(19) United States
(12) Patent Application Publication
(10) Pub. No.: US 2006/0259914 A1
(43) Pub. Date: Nov. 16, 2006

(54) Disc reading apparatus

(75) Inventors: Xiao-Ning Sun, Suzhou City (CN); Li Li, Suzhou (CN); Mei-Rong Gong, Suzhou (CN)

Correspondence Address: SNELL & WILMER, 400 EAST VAN BUREN, ONE ARIZONA CENTER, PHOENIX, AZ, 85004-2202, US

(73) Assignee: BENQ CORPORATION

(21) Appl. No.: 11/432,102

(22) Filed: May 11, 2006

(30) Foreign Application Priority Data
May 11, 2005 (TW) 94115193

(51) Int. Cl. G11B 33/02

(52) U.S. Cl. 720/600

(57) ABSTRACT

The present invention discloses a disc reading apparatus, including a main chassis, a sub-chassis, a spindle motor, a slide unit, and a stopper. The sub-chassis is movably disposed on the main chassis. The spindle motor is disposed on the sub-chassis for rotating a disc. The slide unit touches the slide unit and selectively touches the spindle motor. The slide unit drives the sub-chassis and the stopper so that the sub-chassis, the stopper, and the slide unit are selectively located at a first status and a second status. At the first status, the spindle motor rotates the disc to be read. At the second status, the stopper stops the spindle motor.

### CROSS-REFERENCE TO RELATED APPLICATIONS

This application claims priority to Taiwan Patent Application No. 94115193 entitled “Disc Reading Apparatus,” filed on May 11, 2005, which is incorporated herein by reference and assigned to the assignee herein.

### FIELD OF INVENTION

The present invention generally relates to a disc reading apparatus, and more particularly, to a disc reading apparatus including a stopper for selectively stopping the spindle motor.

### BACKGROUND OF THE INVENTION

In conventional disc reading apparatus, disc ejection is generally conducted either by pressing a disc ejection button manually or by software operation. While ejecting a disc, a spindle motor first applies a reverse current to stop the rotation of the spindle. After the spindle stops, the spindle and the disc-clamper then release the disc. The disc then falls into and is supported by a tray to proceed with the disc ejection operation.

Additionally, a disc reading apparatus is usually equipped with an emergency-disc-ejection mechanism, wherein a mechanical transmission process is involved for compulsory tray ejection. For emergent disc ejection, an eject pin is needed for insertion into an emergency-disc-ejection hole. The emergency-disc-ejection mechanism is often used when the normal disc ejection function fails, such as during situations including a system crash, device breakdown, bad discs and device malfunction due to firmware updating. In other words, sometimes a disc may not stop rotating as desired due to a non-stopping spindle motor resulting from the device breakdown or the system crash. If a user actuates the emergency-disc-ejection mechanism at this time, serious damages, such as a surface scratch resulting from a rotating disc falling on the tray, will result. More serious damages bring about cracked discs, and accidental human injuries may even happen.

Based on the recitations described above, a mechanical-type stopping device is desired for stopping the spindle motor more effectively. More particularly, a stopping device, which ensures that the disc stops rotating and prevents the rotating disc from touching the tray directly, is desired.

### SUMMARY OF THE INVENTION

The present invention provides a disc reading apparatus, including a main chassis, a sub-chassis, a spindle motor, a slide unit, and a stopper. The sub-chassis is movably disposed on the main chassis. The spindle motor is disposed on the sub-chassis for rotating a disc. The slide unit touches the stopper and selectively touches the spindle motor. The slide unit drives the sub-chassis and the stopper so that the sub-chassis, the stopper, and the slide unit are selectively located at a first status and a second status. At the first status, the spindle motor rotates the disc for read-write operation. At the second status, the stopper stops the spindle motor.

In one embodiment of the present invention, the slide unit includes a guiderail, and one end of the stopper is accommodated in the guiderail. When the slide unit shifts from the first status to the second status, the guiderail guides the stopper so that the other end of the stopper touches the spindle motor. When the slide unit shifts from the second status to the first status, the guiderail guides the stopper so that the other end of the stopper departs from the spindle motor. The stopper includes a swayable axle driving the stopper to rotate to touch or depart from the spindle motor.

In another embodiment of the present invention, the slide unit includes a protrusion. When the slide unit shifts from the first status to the second status, the protrusion pushes the stopper so that the other end of the stopper touches the spindle motor.

### BRIEF DESCRIPTION OF THE DRAWINGS

FIG. 1 illustrates an explosion view of featured elements of a disc reading apparatus in accordance with an embodiment of the present invention;

FIG. 2A is a perspective view of the disc reading apparatus showing featured elements of the disc reading apparatus at the first status;

FIG. 2B illustrates a side view of the disc reading apparatus illustrated in FIG. 2A;

FIG. 2C illustrates a top view of the disc reading apparatus illustrated in FIG. 2A;

FIG. 3A is a perspective view of the disc reading apparatus showing featured elements of the disc reading apparatus at the second status;

FIG. 3B illustrates a side view of the disc reading apparatus illustrated in FIG. 3A;

FIG. 3C illustrates a top view of the reading apparatus in FIG. 3A;

FIG. 4A is a schematic diagram of featured elements of a disc reading apparatus at the first status in accordance with another embodiment of the present invention;

FIG. 4B illustrates a side view of the disc reading apparatus illustrated in FIG. 4A;

FIG. 5A is a schematic diagram of the disc reading apparatus showing featured elements of the disc reading apparatus at the second status;

FIG. 5B illustrates a side view of the disc reading apparatus illustrated in FIG. 5A;

FIG. 6A is a schematic diagram of featured elements of a disc reading apparatus at the first status in accordance with still another embodiment of the present invention;

FIG. 6B is a schematic diagram of the disc reading apparatus illustrated in FIG. 6A showing featured elements of the disc reading apparatus at the second status;

FIG. 7 is a schematic diagram of a contact surface of the stopper in accordance with still another embodiment of the present invention; and

FIG. 8 is a schematic diagram of an elastic part of the stopper in accordance with still another embodiment of the present invention.

### DETAILED DESCRIPTION

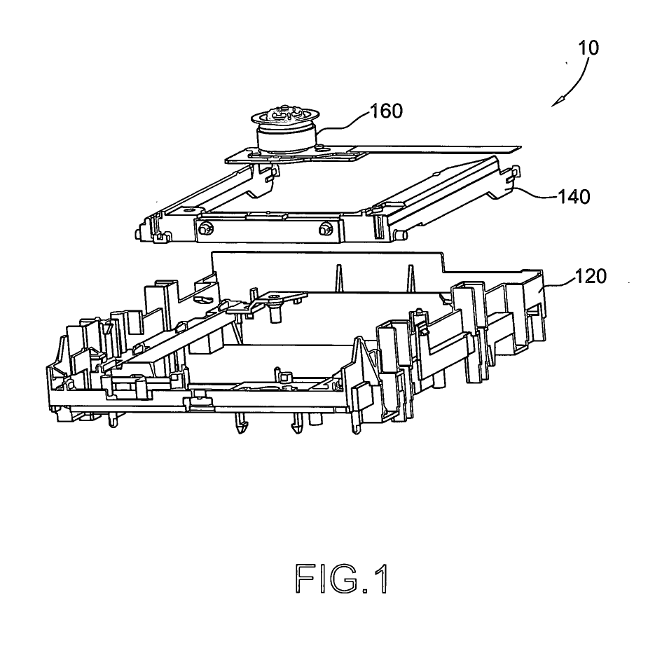

FIG. 1 illustrates an explosion view of featured elements of a disc reading apparatus 10 in accordance with an embodiment of the present invention. For better understanding of the present embodiment, FIG. 1 shows only featured elements of the disc reading apparatus 10, and more detailed descriptions will be made in the following specification and figures. The disc reading apparatus 10 in accordance with the present embodiment includes a main chassis 120, a sub-chassis 140, a spindle motor 160, a slide unit 180, and a stopper 190. The sub-chassis 140 is movably disposed on the main chassis 120. The spindle motor 160 is disposed on the sub-chassis 140 for rotating the disc (not shown). Though the figure shows only featured elements used in the present embodiment, for those skilled in the art, it is known that the disc reading apparatus 10 can further include other components, such as a tray for carrying the disc, a damper for clamping the disc, and reading elements for reading the disc, etc. It should also be understood by those of ordinary skill that this figure is used for illustrating rather than limiting the present invention. The way the sub-chassis 140 is disposed on the main chassis 120 can be any method known in the prior art, such as a slide movement of a protruding shaft guided by a groove, or the like, and no more redundant details will be given here.

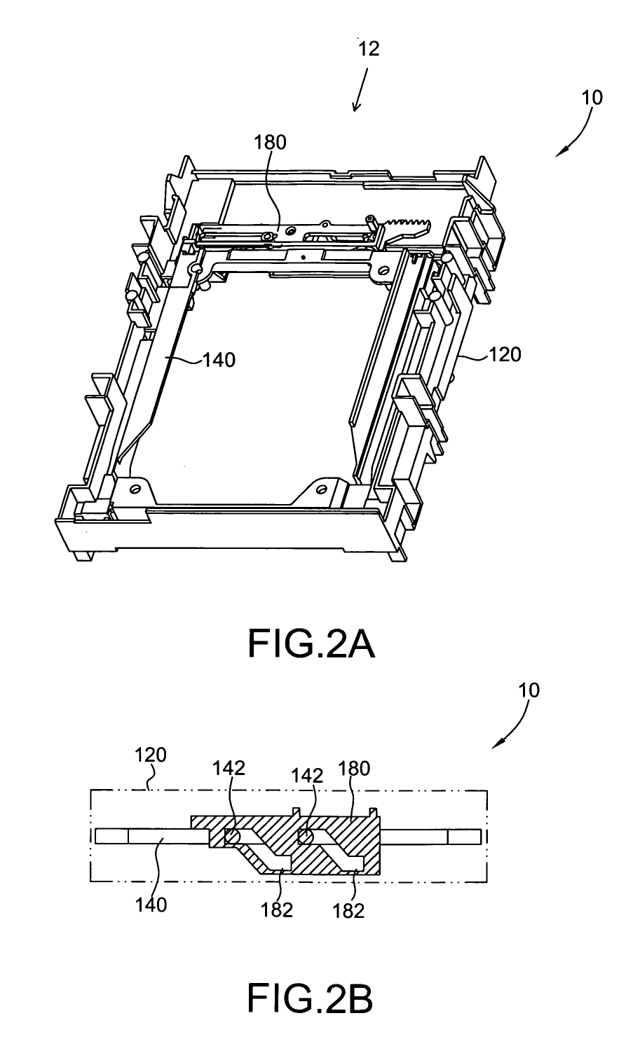

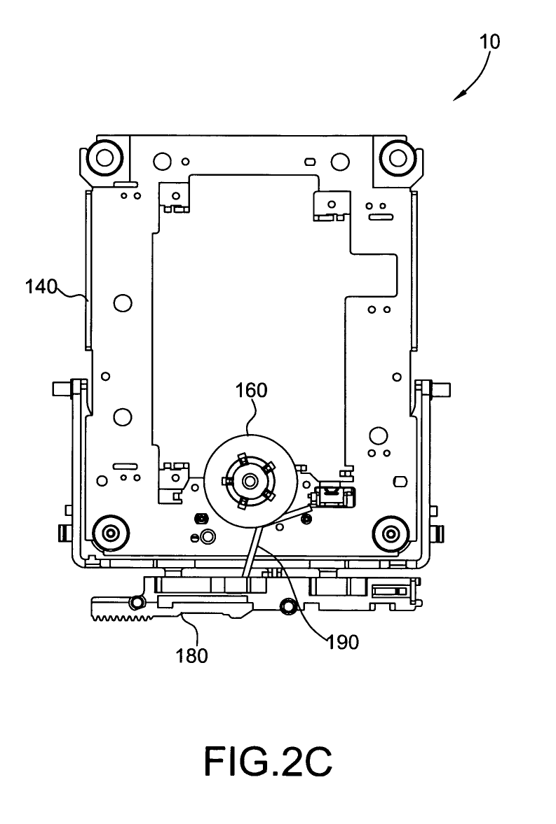

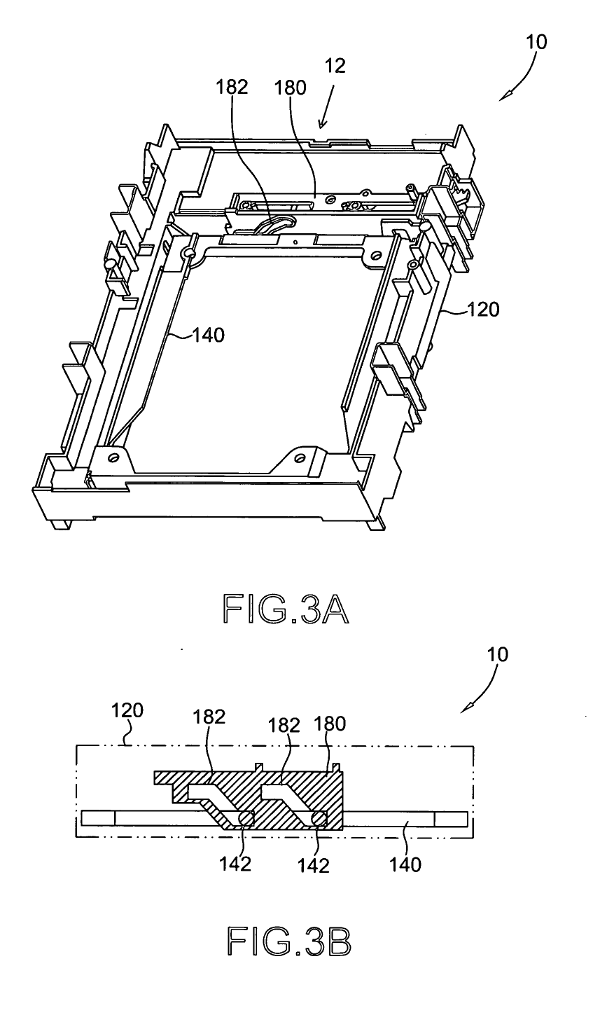

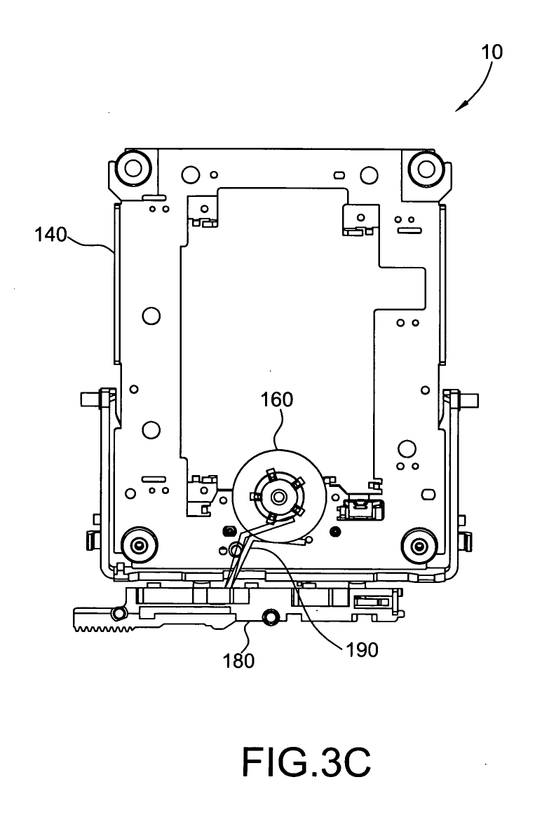

FIGS. 2A to 3C further illustrate the operation of the disc reading apparatus 10 of the present embodiment. The slide unit 180 is movably disposed on the main chassis 120 and touches the sub-chassis 140. In the present embodiment, the slide unit 180 is a cam rack. By engagement with the rack, a drive (not shown) further provided within the disc reading apparatus 10 drives the cam rack. However, those skilled in the art should know that the slide unit 180 can be driven by still other manners. The slide unit 180 drives the sub-chassis 140 and the stopper 190 so that the sub-chassis 140, the stopper 190 and the slide unit 180 are selectively located at a first status and a second status.

FIGS. 2A to 2C illustrate the present embodiment being at the first status. FIG. 2A is a perspective view of the disc reading apparatus 10 showing featured elements of the disc reading apparatus 10. FIG. 2B illustrates a side view of the disc reading apparatus 10 along the direction of the arrow 12 in FIG. 2A. FIG. 2C illustrates a top view of the disc reading apparatus 10 in FIG. 2A. While said sub-chassis, said stopper, and said slide unit are at the first status, the spindle motor 160 disposed on the sub-chassis 140 is used to rotate the disc (not shown) for the disc reading apparatus 10 to read or write data. The way the slide unit 180 drives the sub-chassis 140 can be any method known in the prior art. In the present embodiment, the sub-chassis 140 includes at least a protruding shaft 142, and the slide unit 180 includes at least a groove 182 for accommodating the protruding shaft 142 and guiding the sub-chassis 140 to shift between the first and the second status, as shown in FIG. 2B. In the present embodiment, the stopper 190 is disposed on the slide unit 180, as shown in FIG. 2C.

FIGS. 3A to 3C illustrate the present embodiment being at the second status. FIG. 3A is a perspective view of the disc reading apparatus 10 showing featured elements of the disc reading apparatus 10. FIG. 3B illustrates a lateral cross-sectional view of the disc reading apparatus 10 along the arrow 12 in FIG. 3A. FIG. 3C illustrates a top view of the reading apparatus 10 in FIG. 3A. While said sub-chassis, said stopper, said slide unit are at the second status, the groove 182 of the slide unit 180 guides the movement of the protruding shaft 142 of the sub-chassis 140, as shown in 3B. In response to the movement of the slide unit 180, the other end of the stopper 190 touches the spindle motor 160 so that the spindle motor 160 stops rotating. At this moment, the sub-chassis 142 lowers to a lower elevation making the non-rotation disc proceed to further processes, such as supported by a tray for disc ejection. In the present embodiment, the stopper 190 is preferably an elastic plastic, (e.g., PC, ABS, or PC with glass-fiber, etc.), a rubber rod, an elastic metal or other similar elastic materials. When the stopper 190 touches the spindle motor 160, the stopper 190 bends and deforms to achieve a better braking effect. It should be noted by those skilled in the art that though the stopper 190 described here is elastic, inelastic materials can also be used in other embodiments of the present invention.

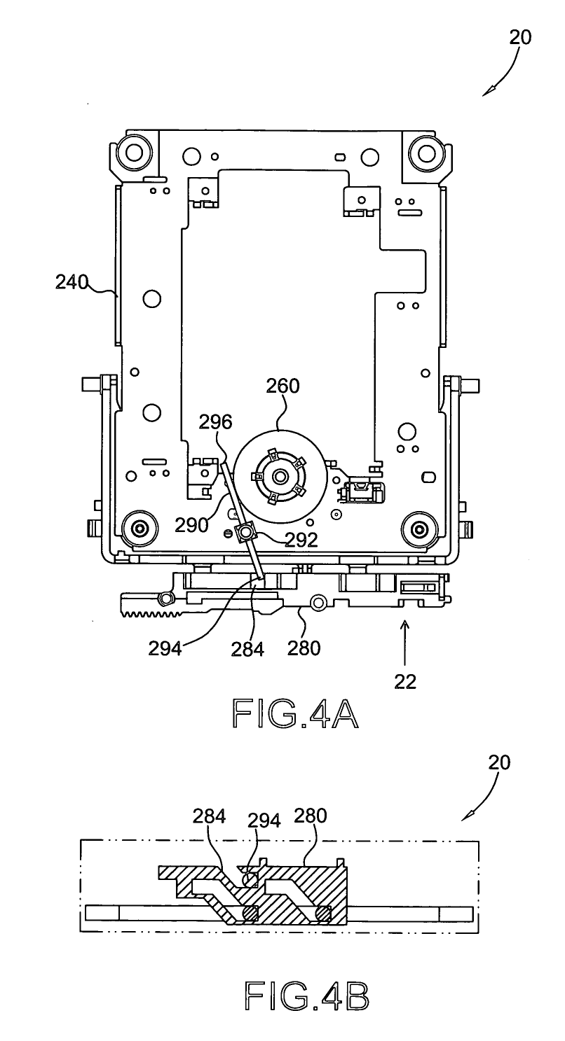

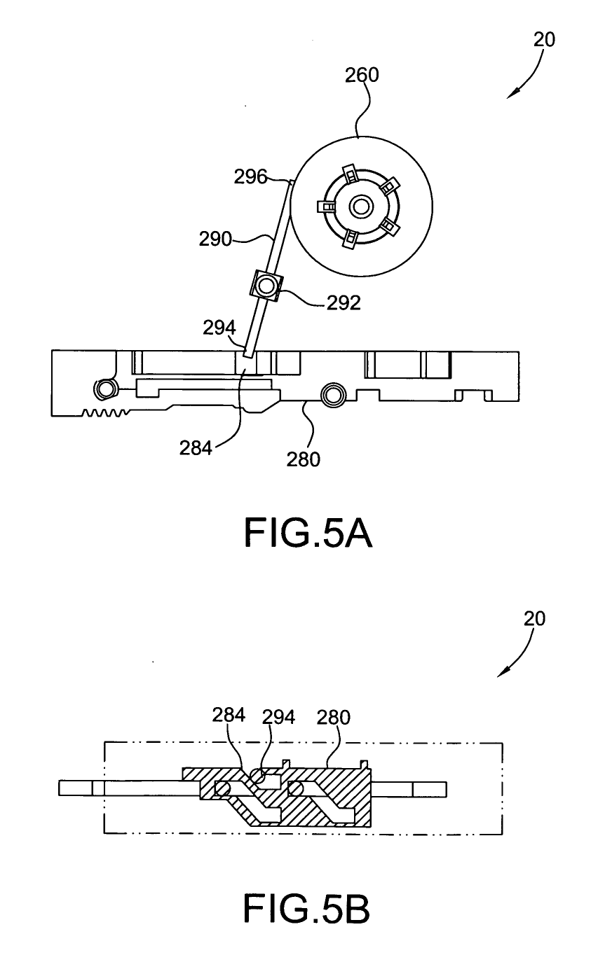

FIGS. 4A to 5B illustrate the operation of a disc reading apparatus 20 in accordance with another embodiment of the present invention.

FIGS. 4A to 4B illustrate the disc reading apparatus 20 being at the first status. FIG. 4A is a schematic diagram of the disc reading apparatus 20. FIG. 4B illustrates a side view of the disc reading apparatus 20. The disc reading apparatus 20 of the present embodiment includes a main chassis (not shown), a sub-chassis 240, a spindle motor 260, a slide unit 280 and a stopper 290. The sub-chassis 240 is movably disposed on the main chassis. The spindle motor 260 is disposed on the sub-chassis 240. The stopper 290 touches the slide unit 280 and selectively touches the spindle motor 260.

In this embodiment, the slide unit 280 includes a guiderail 284, and one end 294 of the stopper 290 is accommodated in the guiderail 284. The stopper 290 includes a swayable axle 292. The stopper 290 is disposed on the sub-chassis 240 by means of the swayable axle 292 and axle 292 performs sway selectively. While said sub-chassis, said stopper, and said slide unit are at the first status, the spindle 260 disposed on the sub-chassis 240 rotates the disc (not shown) for the disc reading apparatus 20 to read or write data.

FIGS. 5A to 5B illustrate the disc reading apparatus 20 of this embodiment being at the second status. When the slide unit 280 shifts from the first status to the second status, the guiderail 284 guides one end 294 of the stopper 290 so that the other end 296 of the stopper 290 touches the spindle motor 260. At this time, the sub-chassis 242 lowers to a lower elevation making the non-rotation disc proceed to further processes. While the above embodiments describe only the switch from the first status to the second status, it should be noted by those of ordinary skill that the movement of shifting from the second status back to the first status is self-explanatory. When the slide unit 280 shifts from the second status to the first status, the guiderail 284 guides one end 294 of the stopper 290 so that the other end 296 of the stopper 290 departs from the spindle motor 260. At this time, the sub-chassis 242 rises back to its original elevation making the disc rotate via the action of spindle motor 260. It should be noted that in this embodiment, elements identical to those in the previous embodiment are not specified again for simplicity purpose.

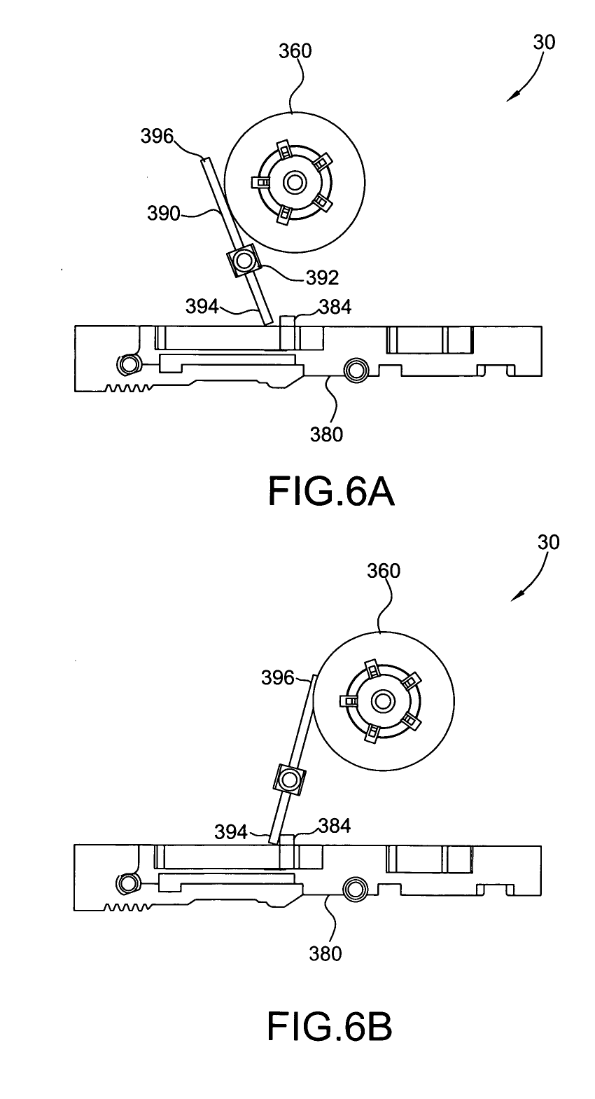

FIGS. 6A to 6B illustrate an enlarged view of a disc reading apparatus 30 in accordance with still another embodiment of the present invention. In this embodiment, a slide unit 380 includes a protrusion 384, and a stopper 390 includes a swayable axle 392.

The stopper 390 is disposed on the sub-chassis (not shown) by means of the swayable axle 392 and the axle 392 performs sway selectively, as shown in FIG. 6A. FIG. 6B illustrates the disc reading apparatus 30 of this embodiment being at the second status. When the slide unit 380 shifts from the first status to the second status, the protrusion 384 pushes one end 394 of the stopper 390 so that the other end 396 of the stopper 390 touches the spindle motor 360, and then stops the spindle motor 360.

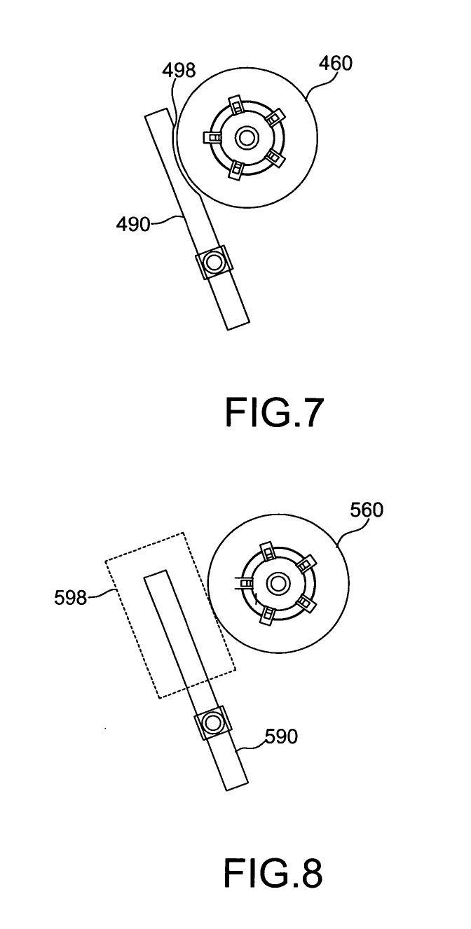

The above-mentioned embodiments are used to describe the present invention; nevertheless, various modifications and changes can be made in the present invention. For example, FIG. 7 illustrates a stopper 490 of another embodiment of the present invention including a contact surface 498. In this embodiment, the contact surface 498 is an arc-surface corresponding to the surface contour of the spindle motor 460. Therefore, the stopper 490 can have larger contact area with the spindle motor 460 through contact surface 498 to improve the braking efficiency. In other embodiments of the present invention, the cross section shape of the stopper 490 may be varied, such as a circle, a square, a rectangular or others. In still another embodiment of the present invention, the contact surface 498 undergoing a coarsening process may increase its friction with the spindle motor.

In another embodiment of the present invention, a stopper 590 in FIG. 8 further includes an elastic part 598. The elastic part 598 buffers its contact with the spindle motor 560. Similarly, the elastic part 598 can also be coarsened so that the surface of the elastic part 598 provides more friction between itself and the spindle motor 560.

It is to be noted that, the present invention is not limited by the specific embodiments described above. The invention covers various modifications and equivalent arrangements included within the true spirit and scope of the appended claims.

What is claimed is:

1. A disc reading apparatus, comprising:
a main chassis;
a sub-chassis movably disposed on said main chassis;
a spindle motor disposed on said sub-chassis;
a slide unit movably disposed on said main chassis and touching said sub-chassis; and
a stopper touching said slide unit and selectively touching said spindle motor;
wherein said slide unit drives said sub-chassis and said stopper so that said sub-chassis, said stopper, and said slide unit are selectively located at a first status and a second status, and when said sub-chassis, said stopper, and said slide unit are at said first status, said spindle motor rotates a disc, and when said sub-chassis, said stopper, and said slide unit are at said second status, said stopper stops said spindle motor.

2. The disc reading apparatus of claim 1, wherein said slide unit further comprises a guiderail and one end of said stopper is accommodated in said guiderail, when said slide unit shifts from said first status to said second status, said guiderail guides said stopper so that the other end of said stopper touches said spindle motor.

3. The disc reading apparatus of claim 2, wherein when said slide unit shifts from said second status to said first status, said guiderail guides said stopper so that the other end of said stopper departs from said spindle motor.

4. The disc reading apparatus of claim 2, wherein said stopper further comprises a swayable axle driving said stopper to rotate to touch or depart from said spindle motor.

5. The disc reading apparatus of claim 1, wherein said slide unit comprises a cam rack.

6. The disc reading apparatus of claim 1, wherein said slide unit further comprises a protrusion, and when said slide unit shifts from said first status to said second status, said protrusion pushes said stopper so that the other end of said stopper touches said spindle motor.

7. The disc reading apparatus of claim 1, wherein said stopper is movably disposed on said sub-chassis.

8. The disc reading apparatus of claim 1, wherein said stopper is disposed on said slide unit.

9. The disc reading apparatus of claim 1, wherein said stopper further comprises an elastic part touching said spindle motor for buffering the contact between said stopper and said spindle motor.

10. The disc reading apparatus of claim 1, wherein said stopper further comprises a contact surface touching said spindle motor, and a shape of said contact surface corresponds to a shape of said spindle motor to increase the contact area.

11. The disc reading apparatus of claim 1, wherein said shape of said stopper includes a circle, a triangle, a square or a rectangle.
